(19) United States
(12) Patent Application Publication
(10) Pub. No.: US 2023/0273304 A1
(43) Pub. Date: Aug. 31, 2023

(54) Efficient Fault Detection For Lidar Sensors

(71) Applicant: Ouster, Inc., San Francisco, CA (US)

(72) Inventor: David Storrar, Falkirk (GB)

(73) Assignee: Ouster, Inc., San Francisco, CA (US)

(21) Appl. No.: 18/150,963

(22) Filed: Jan. 6, 2023

Related U.S. Application Data
(60) Provisional application No. 63/297,624, filed on Jan. 7, 2022.

(51) Int. Cl. G01S 7/497; G01S 17/89

(52) U.S. Cl. CPC G01S 7/497; G01S 17/89

(57) ABSTRACT

Embodiments describe in-pixel sensor fault detection system that includes plurality of photodetectors to generate signals when a photon is detected, and the number of photons detected for each photosensor is accumulated through a first data path to obtain a first number of total triggered photodetectors of the corresponding photosensor through a first data path and stored in a memory. The memory stores photon counts in time bins based on photon arrival times to form a histogram representation. The number of photons detected for each photosensor is accumulated through a second data path to obtain a second number of total triggered photodetectors of each corresponding photosensor in an integration register. The first number of total triggered photodetectors is compared against the second number of total triggered photodetectors. When the comparison returns an inconsistency, the system flags the corresponding photosensor for further possible actions.

### CROSS-REFERENCES TO RELATED APPLICATIONS

The present application claims priority from and is a non-provisional application of U.S. Provisional Application No. 63/297,624, entitled “Efficient Fault Detection For Lidar Sensors” filed Jan. 7, 2022, the entire contents of which is herein incorporated by reference for all purposes.

### BACKGROUND

This disclosure relates generally to lidar systems and more specifically to lidar systems resilient to faults.

Time of flight (ToF) based imaging is used in a number of applications, including range finding, depth profiling, and 3D imaging, such as light imaging, detection, and ranging (LiDAR, or lidar). Direct time of flight (dToF) measurement includes directly measuring the length of time between emitting radiation from emitter element(s) and sensing the radiation by detector element(s) after reflection from an object or other target. The distance to the target can be determined from the measured length of time. Indirect time of flight measurement includes determining the distance to the target by phase modulating the amplitude of the signals emitted by the emitter element(s) of the lidar system and measuring phases (e.g., with respect to delay or shift) of the echo signals received at the detector element(s) of the lidar system. These phases may be measured with a series of separate measurements or samples.

In specific applications, the sensing of the reflected radiation in either direct or indirect time of flight systems may be performed using an array of detectors, such as an array of Single Photon Avalanche Diodes (SPADs). One or more detectors may define a sensor (also referred to as a “pixel”) of the sensor array used to generate a lidar image for the depth (range) to objects for respective pixels.

When imaging a scene, ToF sensors (also referred to as photosensors) for lidar applications can include circuits that time-stamp and/or count incident photons as reflected from a target. Data rates can be compressed by histogramming timestamps. For instance, for each pixel, a histogram having bins (also referred to as “time bins”) corresponding to different ranges of photon arrival times can be stored in memory, and photon counts can be accumulated in different time bins of the histogram according to their arrival time. A time bin can correspond to a time range of, e.g., 1 ns, 2 ns, or the like.

Some lidar systems may perform in-pixel histogramming of incoming photons using a clock-driven architecture and a limited memory block, which may provide a significant increase in histogramming capacity. However, since memory capacity is limited and typically cannot cover the desired distance range at once, such lidar systems may operate in “strobing” mode. “Strobing” can refer to the generation of detector control signals (also referred to herein as “strobe signals” or “strobes”) to control the timing and/or duration of activation (also referred to herein as “detection windows” or “strobe windows”) of one or more detectors of the lidar system, such that photon detection and histogramming is performed sequentially over a set of different time windows, each corresponding to an individual distance subrange, so as to collectively define the entire distance range. In other words, partial histograms may be acquired for subranges or “time slices” corresponding to different sub-ranges of the distance range and then amalgamated into one full-range histogram. Thousands of time bins (each corresponding to respective photon arrival times) may typically be used to form a histogram sufficient to cover the typical time range of a lidar system (e.g., microseconds) with the typical time-to-digital converter (TDC) resolution (e.g., 50 to 100 picoseconds).

When lidar is incorporated into road vehicles, it must meet the ISO functional safety standard, or the Automotive Safety Integrity Level B (ASIL-B) requirement. ASIL-B requires the number of detectable faults to be greater than 90%. Conventional Built-In-Self-Test (BIST) techniques, however, cannot be used for in-pixel detection systems because of the limited available idle time and capacity of pixels. Similarly, traditional fault detecting methods relying on logic replication cannot be effectively incorporated within SPAD-based lidar systems due to the deficiency of available space within pixels. Therefore, there is a need for a more efficient and accurate in-pixel sensor fault detection method in SPAD-based lidar systems for functional

### SUMMARY

Certain embodiments of the disclosure can provide to a lidar sensor fault detection operation that can use an independent, in-pixel integration register tracking a number (e.g., a sum or modulo operation) of photon counts (e.g., triggered photodetectors), comparing the counts in the integration register against an aggregation (e.g., a sum or modulo operation) of photon counts (e.g., triggered photodetector counts) across all the histogram bins, and flagging an error when the comparison indicates a difference.

As an example, an optical measurement system of SPAD-based lidar may include a photosensor corresponding to a particular pixel in a ranging measurement. A photosensor can include one or more photodetectors. Each of the photodetectors (e.g., a SPAD) may generate signals when a photon is detected, and each of the respective signals can be compared to a threshold to determine whether a corresponding photodetector is triggered. Based on the number of photodetectors returning signals, the number of triggered photodetectors for each pixel may be accumulated in an integration register independent of a parallel data path that stores triggered photodetector counts in time bins based on photon arrival times to form a histogram representation. The total triggered photodetector counts in the integration register (“total register count”) can be compared against the sum of triggered photodetector counts across all the histogram bins (“total histogram count”) to identify and flag faulty pixels.

According to some embodiments, modulo operations (e.g., modulo-X) may be implemented to determine a “total register count” and the “total histogram count” described above to create reduced-width counters that can be incorporated into pixels to provide efficient in-pixel error detection.

These and other embodiments of the disclosure are described in detail below. For example, other embodiments are directed to systems, devices, and computer readable media associated with methods described herein.

A better understanding of the nature and advantages of embodiments of the disclosed embodiments can be gained with reference to the following detailed description and the accompanying drawings. It is to be understood, however, that each of the figures is provided for the purpose of illustration only and is not intended as a definition of the limits of the scope of the invention. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1 is a simplified block diagram of a Light Detection and Ranging (lidar) system according to some embodiments;

FIG. 2 is a simplified block diagram of components of a time-of-flight measurement system or circuit according to some embodiments;

FIG. 3 illustrates the operation of a typical lidar system that may be improved by embodiments;

FIG. 4 shows a histogram according to embodiments of the present invention;

FIG. 5 shows the accumulation of a histogram over multiple pulse trains for a selected pixel according to embodiments of the present invention;

FIG. 6 shows a circuit for receiving photons and generating a set of signals that are stored in a memory representing histogram, according to some embodiments of the present invention;

FIG. 7 shows a simplified block diagram of a lidar sensor fault detection system according to some embodiments of the present invention;

FIG. 8 shows a data path with an integration register, according to some embodiments of the present invention;

FIG. 9 shows block diagram of a lidar sensor fault detection system according to some embodiments of the present invention;

FIG. 10 shows block diagram of a lidar sensor fault detection system incorporating modulo operations according to some embodiments of the present invention;

FIG. 11 shows a flowchart of a method of using a lidar sensor fault detection system, according to some embodiments of the present invention;

FIG. 12 shows a simplified illustration of an automobile including solid-state flash lidar sensors at different locations along the automobile, according to some embodiments of the present invention.

### DETAILED DESCRIPTION

The present disclosure relates generally to the field of sensor error detection in lidar systems, and more particularly to the use of independent in-pixel integration registers and modulo operations that can be incorporated into pixels with limited memory capacity. Various improvements can be realized with various embodiments of the present invention. Such improvements can be increased efficiency, error detection coverage, and reduced logic and memory consumption.

### I. Example Lidar System

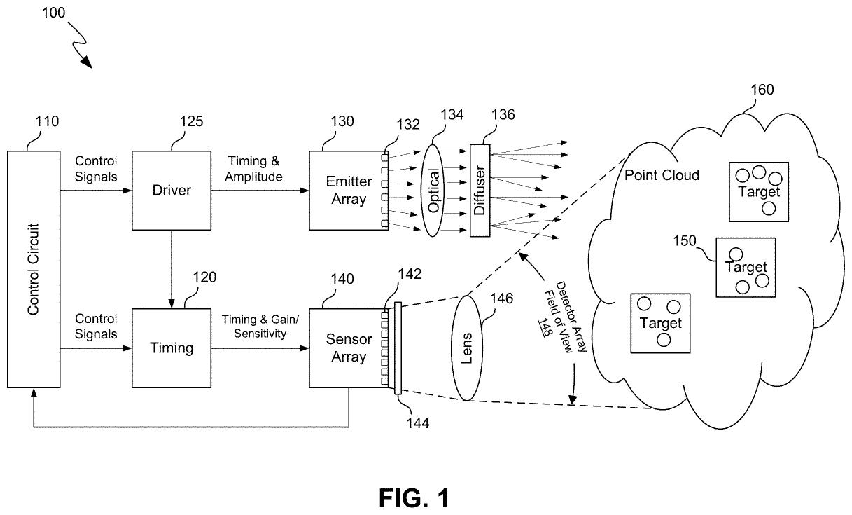

FIG. 1 illustrates an example light-based 3D sensor system 100, such as a Light Detection and Ranging (LiDAR, or lidar) system, in accordance with some embodiments of the present disclosure. Lidar system 100 can include a control circuit 110, a timing circuit 120, driver circuitry 125, an emitter array 130 and a sensor array 140. Emitter array 130 can include a plurality of emitter units 132 arranged in an array (e.g., a one- or two-dimensional array) and sensor array 140 can include a plurality of sensors (also referred to as “pixels”) 142 arranged in an array (e.g., a one- or two-dimensional array). The sensors 142 can be depth sensors, such as time-of-flight ToF sensors. In some embodiments, each sensor 142 can include, for example, an array of single-photon detectors, such as single-photon avalanche diodes (SPADs). In some embodiments, each sensor 142 can be coupled to an in-pixel memory block (not shown) that accumulates histogram data for that sensor 142, and the combination of a sensor and in-pixel memory circuitry is sometimes referred to as a “pixel” 142. Each emitter unit 132 of the emitter array 130 can include one or more emitter elements that can emit a radiation pulse (e.g., light pulse) or continuous wave signal at a time and frequency controlled by a timing generator or driver circuitry 125. In some embodiments, the emitter units 132 can be pulsed light sources, such as LEDs or lasers such as vertical cavity surface emitting lasers (VCSELs) that emit a cone of light (e.g., infrared light) having a predetermined beam divergence.

Emitter array 130 can project pulses of radiation into a field of view of the lidar system 100. Some of the emitted radiation can then be reflected back from objects in the field, such as targets 150. The radiation that is reflected back can then be sensed or detected by the sensors 142 within the sensor array 140. Control circuit 110 can implement a processor that measures and/or calculates the distance to targets 150 based on data (e.g., histogram data) provided by sensors 142. In some embodiments, control circuit 110 can measure and/or calculate the time of flight of the radiation pulses over the journey from emitter array 130 to target 150 and back to the sensors 142 within the sensor array 140 using direct or indirect time of flight (ToF) measurement techniques.

In some embodiments, emitter array 130 can include an array (e.g., a one- or two-dimensional array) of emitter units 132 where each emitter unit is a unique semiconductor chip having one or more individual VCSELs (sometimes referred to herein as emitter elements) formed on the chip. An optical element 134 and a diffuser 136 can be disposed in front of the emitter units such that light projected by the emitter units passes through the optical element 134 (which can include, e.g., one or more Fresnel lenses) and then through diffuser 136 prior to exiting lidar system 100. In some embodiments, optical element 134 can be an array of lenses or lenslets (in which case the optical element is sometimes referred to herein as “lens array 134” or “lenslet array 134”) that collimate or reduce the angle of divergence of light received at the array and pass the altered light to diffuser 136. The diffuser 136 can be designed to spread light received at the diffuser over an area in the field that can be referred to as the field of view of the emitter array (or the field of illumination of the emitter array). In general, in these embodiments, emitter array 130, lens array 134 and diffuser 136 cooperate to spread light from emitter array 130 across the entire field of view of the emitter array. A variety of emitters and optical components can be used.

The driver circuitry 125 can include one or more driver circuits each of which controls one or more emitter units. The driver circuits can be operated responsive to timing control signals with reference to a master clock and/or power control signals that control the peak power and/or the repetition rate of the light output by the emitter units 132. In some embodiments, each of the emitter units 132 in the emitter array 130 is connected to and controlled by a separate circuit in driver circuitry 125. In other embodiments, a group of emitter units 132 in the emitter array 130 (e.g., emitter units 132 in spatial proximity to each other or in a common column of the emitter array), can be connected to a same circuit within driver circuitry 125. Driver circuitry 125 can include one or more driver transistors configured to control the modulation frequency, timing, and/or amplitude of the light (optical emission signals) output from the emitter units 132.

In some embodiments, a single event of emitting light from the multiple emitter units 132 can illuminate an entire image frame (or field of view); this is sometimes referred to as a “flash” lidar system. Other embodiments can include non-flash or scanning lidar systems, in which different emitter units 132 emit light pulses at different times, e.g., into different portions of the field of view. The maximum optical power output of the emitter units 132 can be selected to generate a signal-to-noise ratio of the echo signal from the farthest, least reflective target at the brightest background illumination conditions that can be detected in accordance with embodiments described herein. In some embodiments, an optical filter (not shown) such as a bandpass filter can be included in the optical path of the emitter units 132 to control the emitted wavelengths of light.

Light output from the emitter units 132 can impinge on and be reflected back to lidar system 100 by one or more targets 150 in the field. The reflected light can be detected as an optical signal (also referred to herein as a return signal, echo signal, or echo) by one or more of the sensors 142 (e.g., after being collected by receiver optics 146), converted into an electrical signal representation (sometimes referred to herein as a detection signal), and processed (e.g., based on time of flight techniques) to define a 3-D point cloud representation 160 of a field of view 148 of the sensor array 140. In some embodiments, operations of lidar systems can be performed by one or more processors or controllers, such as control circuit 110.

Sensor array 140 includes an array of sensors 142. In some embodiments, each sensor 142 can include one or more photodetectors, e.g., SPADs. And in some particular embodiments, sensor array 140 can be a very large array made up of hundreds of thousands or even millions of densely packed SPADs. Receiver optics 146 and receiver electronics (including timing circuit 120) can be coupled to the sensor array 140 to power, enable, and disable all or parts of the sensor array 140 and to provide timing signals thereto. In some embodiments, sensors 142 can be activated or deactivated with at least nanosecond precision (supporting time bins of 1 ns, 2 ns etc.), and in various embodiments, sensors 142 can be individually addressable, addressable by group, and/or globally addressable. The receiver optics 146 can include a bulk optic lens that is configured to collect light from the largest field of view that can be imaged by the lidar system 100, which in some embodiments is determined by the aspect ratio of the sensor array combined with the focal length of the receiver optics 146.

In some embodiments, the receiver optics 146 can further include various lenses (not shown) to improve the collection efficiency of the sensors, and/or an anti-reflective coating (also not shown) to reduce or prevent detection of stray light. In some embodiments, a spectral filter 144 can be positioned in front of the sensor array 140 to pass or allow passage of ‘signal’ light (i.e., light of wavelengths corresponding to wavelengths of the light emitted from the emitter units) but substantially reject or prevent passage of non-signal light (i.e., light of wavelengths different from the wavelengths of the light emitted from the emitter units).

The sensors 142 of sensor array 140 are connected to the timing circuit 120. The timing circuit 120 can be phase-locked to the driver circuitry 125 of emitter array 130. The sensitivity of each of sensors 142 or of groups of sensors 142 can be controlled. For example, when the detector elements include reverse-biased photodiodes, avalanche photodiodes (APD), PIN diodes, and/or Geiger-mode avalanche diodes (e.g., SPADs), the reverse bias can be adjusted. In some embodiments, a higher overbias provides higher sensitivity.

In some embodiments, control circuit 110, which can be, for example, a microcontroller or microprocessor, provides different emitter control signals to the driver circuitry 125 of different emitter units 132 and/or provides different signals (e.g., strobe signals) to the timing circuit 120 of different sensors 142 to enable/disable the different sensors 142 so as to detect the echo signal (or returning light) from the target 150. The control circuit 110 can also control memory storage operations for storing data indicated by the detection signals in a non-transitory memory or memory array that is included therein or is distinct therefrom.

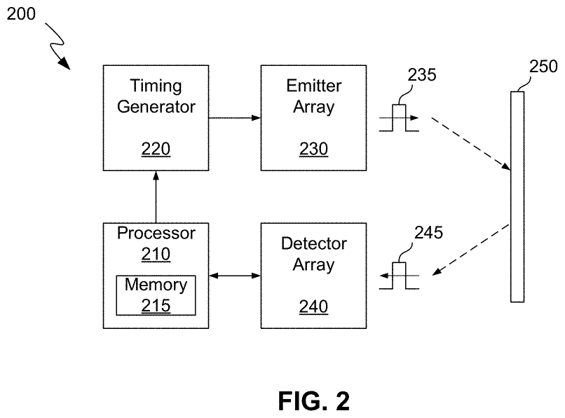

FIG. 2 further illustrates components of a ToF measurement system or circuit 200 in a lidar application in accordance with some embodiments described herein. The circuit 200 can include a processor circuit 210 (such as a digital signal processor (DSP)), a timing generator 220 that controls timing of the illumination source (illustrated by way of example with reference to a laser emitter array 230), and an array of sensors (illustrated by way of example with reference to a sensor array 240). The processor circuit 210 can also include a sequencer circuit (not shown in FIG. 2) that is configured to coordinate operation of emitter units within the illumination source (emitter array 230) and sensors within the sensor array 240.

The processor circuit 210 and the timing generator 220 can implement some of the operations of the control circuit 110 and the driver circuitry 125 of FIG. 1. Similarly, emitter array 230 and sensor array 240 can be representative of emitter array 130 and sensor array 140 in FIG. 1. The laser emitter array 230 can emit laser pulses 235 at times controlled by the timing generator 220. Light 245 from the laser pulses 235 can be reflected back from a target (illustrated by way of example as object 250) and can be sensed by sensor array 240. The processor circuit 210 implements a pixel processor that can measure or calculate the time of flight of each laser pulse 235 and its reflected signal 245 over the journey from emitter array 230 to object 250 and back to the sensor array 240.

The processor circuit 210 can provide analog and/or digital implementations of logic circuits that provide the necessary timing signals (such as quenching and gating or strobe signals) to control operation of single-photon detectors of the sensor array 240 and that process the detection signals output therefrom. For example, individual single-photon detectors of sensor array 240 can be operated such that they generate detection signals in response to incident photons only during the gating intervals or strobe windows that are defined by the strobe signals, while photons that are incident outside the strobe windows have no effect on the outputs of the single photon detectors. More generally, the processor circuit 210 can include one or more circuits that are configured to generate detector control signals that control the timing and/or durations of activation of the sensors 142 (or particular single-photon detectors therein), and/or to generate respective emitter control signals that control the output of light from the emitter units 132.

Detection events can be identified by the processor circuit 210 based on one or more photon counts indicated by the detection signals output from the sensor array 240, which can be stored in a non-transitory memory 215. In some embodiments, the processor circuit 210 can include a correlation circuit or correlator that identifies detection events based on photon counts (referred to herein as correlated photon counts) from two or more single-photon detectors within a predefined window (time bin) of time relative to one another, referred to herein as a correlation window or correlation time, where the detection signals indicate arrival times of incident photons within the correlation window. Since photons corresponding to the optical signals output from the emitter array 230 (also referred to as signal photons) can arrive relatively close in time with each other, as compared to photons corresponding to ambient light (also referred to as background photons), the correlator can be configured to distinguish signal photons based on respective times of arrival being within the correlation time relative to one another. Such correlators and strobe windows are described, for example, in U.S. Patent Application Publication No. 2019/0250257, entitled “Methods and Systems for High-Resolution Long Range Flash Lidar,” which is incorporated by reference herein in its entirety for all purposes.

The processor circuit 210 can be small enough to allow for three-dimensionally stacked implementations, e.g., with the sensor array 240 “stacked” on top of processor circuit 210 (and other related circuits) that is sized to fit within an area or footprint of the sensor array 240. For example, some embodiments can implement the sensor array 240 on a first substrate, and transistor arrays of the processor circuit 210 on a second substrate, with the first and second substrates/wafers bonded in a stacked arrangement, as described for example in U.S. Patent Application Publication No. 2020/0135776, entitled “High Quantum Efficiency Geiger-Mode Avalanche Diodes Including High Sensitivity Photon Mixing Structures and Arrays Thereof,” the disclosure of which is incorporated by reference herein in its entirety for all purposes.

The pixel processor implemented by the processor circuit 210 can be configured to calculate an estimate of the average ToF aggregated over hundreds or thousands of laser pulses 235 and photon returns in reflected light 245. The processor circuit 210 can be configured to count incident photons in the reflected light 245 to identify detection events (e.g., based on one or more SPADs within the sensor array 240 that have been “triggered”) over a laser cycle (or portion thereof).

The timings and durations of the detection windows can be controlled by a strobe signal (Strobe #i or Strobe<i>). Many repetitions of Strobe #i can be aggregated (e.g., in the pixel) to define a sub-frame for Strobe #i, with subframes i=1 to n defining an image frame. Each sub-frame for Strobe #i can correspond to a respective distance sub-range of the overall imaging distance range. In a single-strobe system, a sub-frame for Strobe #i can correspond to the overall imaging distance range and is the same as an image frame since there is a single strobe. The time between emitter unit pulses (which defines a laser cycle, or more generally emitter pulse frequency) can be selected to define or can otherwise correspond to the desired overall imaging distance range for the ToF measurement system 200. Accordingly, some embodiments described herein can utilize range strobing to activate and deactivate sensors for durations or “detection windows” of time over the laser cycle, at variable delays with respect to the firing of the laser, thus capturing reflected correlated signal photons corresponding to specific distance sub-ranges at each window/frame, e.g., to limit the number of ambient photons acquired in each laser cycle.

The strobing can turn off and on individual photodetectors or groups of photodetectors (e.g., for a pixel), e.g., to save energy during time intervals outside the detection window. For instance, a SPAD or other photodetector can be turned off during idle time, such as after an integration burst of time bins and before a next laser cycle. As another example, SPADs can also be turned off while all or part of a histogram is being read out from non-transitory memory 215. Yet another example is when a counter for a particular time bin reaches the maximum value (also referred to as “bin saturation”) for the allocated bits in the histogram stored in non-transitory memory 215. A control circuit can provide a strobe signal to activate a first subset of the sensors while leaving a second subset of the sensors inactive. In addition or alternatively, circuitry associated with a sensor can also be turned off and on as specified times.

### II. Detection of Reflected Pulses

The photosensors can be arranged in a variety of ways for detecting reflected pulses. For example, the photosensors can be arranged in an array, and each photosensor can include an array of photodetectors (e.g., SPADs). A signal from a photodetector indicates when a photon was detected and potentially how many photons were detected. For example, a SPAD can operate in a single-photon detection mode. This single-photon detection mode of operation is often referred to as “Geiger Mode,” and an avalanche can produce a current pulse that results in a photon being counted, which may be output as binary signals. Other photodetectors (e.g., for an avalanche photodiode) can produce an analog signal (in real time) proportional to the number of photons detected. The signals from individual photodetectors can be combined to provide a signal from the sensor, which can be a digital signal. This signal can be used to generate histograms.

A. Time-Of-Flight Measurements And Detectors

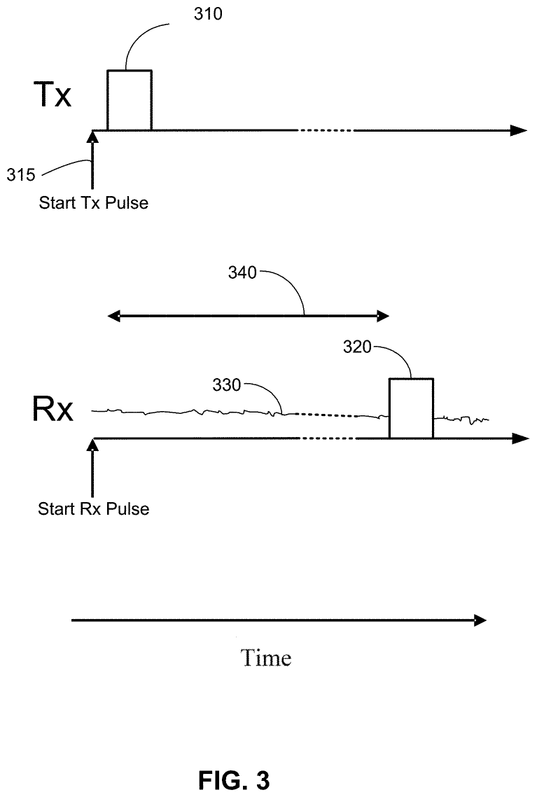

FIG. 3 illustrates the operation of a typical lidar system that may be improved by some embodiments. A laser or other emitter (e.g., within emitter array 230 or emitter array 130) generates a light pulse 310 of short duration. The horizontal axis represents time and the vertical axis represents power. An example laser pulse duration, characterized by the full-width half maximum (FWHM), is a few nanoseconds, with the peak power of a single emitter being around a few watts. Embodiments that use side emitter lasers or fiber lasers may have much higher peak powers, while embodiments with small diameter VCSELs could have peak powers in the tens of milliwatts to hundreds of milliwatts.

A start time 315 for the emission of the pulse does not need to coincide with the leading edge of the pulse. As shown, the leading edge of light pulse 310 may be after the start time 315. One may want the leading edge to differ in situations where different patterns of pulses are transmitted at different times, e.g., for coded pulses. In this example, a single pulse of light is emitted. In some embodiments, a sequence of multiple pulses can be emitted, and the term “pulse train” as used herein refers to either a single pulse or a sequence of pulses.

An optical receiver system (which can include, e.g., sensor array 240 or sensor array 140) can start detecting received light at the same time as the laser is started, i.e., at the start time. In other embodiments, the optical receiver system can start at a later time, which is at a known time after the start time for the pulse. The optical receiver system detects background light 330 initially and after some time detects the laser pulse reflection 320. The optical receiver system can compare the detected light intensity against a threshold to identify the laser pulse reflection 320. Where a sequence of pulses are emitted, the optical receiver system can detect each pulse. The threshold can distinguish the background light 330 from light corresponding to the laser pulse reflection 320.

The time-of-flight 340 is the time difference between the pulse 310 being emitted and the reflected pulse 320 being received. The time difference can be measured by subtracting the emission time of the pulse 310 (e.g., as measured relative to the start time) from a received time of the reflected pulse 320 (e.g., also measured relative to the start time). The distance to the target can be determined as half the product of the time-of-flight and the speed of light. Pulses from the laser device reflect from objects in the scene at different times, depending on start time and distance to the object, and the sensor array detects the pulses of reflected light.

B. Histogram Signals From Photodetectors

One mode of operation of a lidar system is time-correlated single photon counting (TCSPC), which is based on counting single photons in a periodic signal. This technique works well for low levels of periodic radiation which is suitable in a lidar system. This time correlated counting may be controlled by a periodic signal, e.g., from timing generator 220.

The frequency of the periodic signal can specify a time resolution within which data values of a signal are measured. For example, one measured value can be obtained for each photosensor per cycle of the periodic signal. In some embodiments, the measurement value can be the number of photodetectors that triggered during that cycle. The time period of the periodic signal corresponds to a time bin, with each cycle being a different time bin.

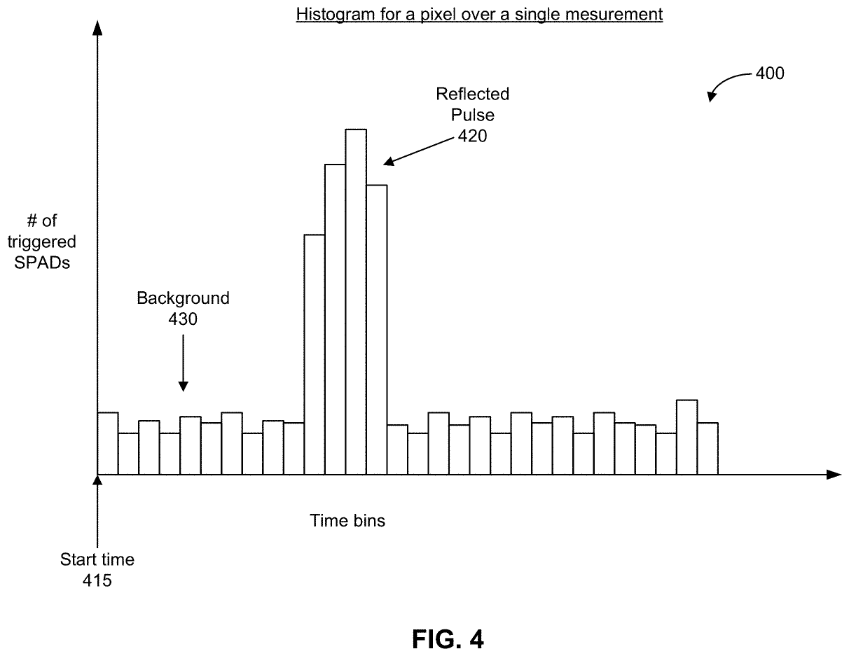

FIG. 4 shows a histogram 400 according to some embodiments described herein. The horizontal axis corresponds to time bins as measured relative to start time 415. As described above, start time 415 can correspond to a start time for an emitted pulse train. Any offsets between rising edges of the first pulse of a pulse train and the start time for either or both of a pulse train and a detection time interval can be accounted for when determining the received time to be used for the time-of-flight measurement. In this example, the sensor pixel includes a number of SPADs, and the vertical axis corresponds to the number of triggered SPADs for each time bin. Other types of photodetectors can also be used. For instance, in embodiments where APDs are used as photodetectors, the vertical axis may correspond to an output of an analog-to-digital converter (ADC) that receives the analog signal from an APD. It is noted that APDs and SPADS can both exhibit saturation effects. Where SPADs are used, a saturation effect can lead to dead time for the pixel (e.g., when all SPADs in the pixel are immediately triggered and no SPADs can respond to later-arriving photons). Where APDs are used, saturation can result in a constant maximum signal rather than the dead-time based effects of SPADs. Some effects can occur for both SPADs and APDs, e.g., pulse smearing of very oblique surfaces may occur for both SPADs and APDs.

The counts of triggered SPADs for each of the time bins correspond to the different bars in histogram 400. The counts at the early time bins are relatively low and correspond to background noise 430. At some point, a reflected pulse 420 is detected. The corresponding counts are much larger, and may be above a threshold that discriminates between background and a detected pulse. The reflected pulse 420 results in increased counts in four time bins, which might result from a laser pulse of a similar width, e.g., a 4 ns pulse when time bins are each 1 ns.

The temporal location of the time bins corresponding to reflected pulse 420 can be used to determine the received time, e.g., relative to start time 415. In some embodiments, matched filters can be used to identify a pulse pattern, thereby effectively increasing the signal-to-noise ratio and allowing a more accurate determination of the received time. In some embodiments, the accuracy of determining a received time can be less than the time resolution of a single time bin. For instance, for a time bin of 1 ns, a resolution of one time bin would correspond to a distance about 15 cm. However, it can be desirable to have an accuracy of only a few centimeters.

Accordingly, a detected photon can result in a particular time bin of the histogram being incremented based on its time of arrival relative to a start signal, e.g., as indicated by start time 415. The start signal can be periodic such that multiple pulse trains are sent during a measurement. Each start signal can be synchronized to a laser pulse train, with multiple start signals causing multiple pulse trains to be transmitted over multiple laser cycles (also sometimes referred to as “shots”). A shot can occur over a detection time interval (also referred to as a detection interval, time interval, or laser cycle). An entire measurement can be over a measurement time interval (or just “measurement interval”), which may equal N detection intervals of an optical measurement or be longer, e.g., when pauses occur between detection intervals. Thus, a time bin (e.g., from 200 to 201 ns after the start signal) would occur for each detection interval. The histogram can accumulate the counts, with the count of a particular time bin corresponding to a sum of the measured data values all occurring in that particular time bin across multiple shots. When the detected photons are histogrammed based on such a technique, the result can be a return signal having a signal to noise ratio greater than that from a single pulse train by the square root of the number of shots taken.

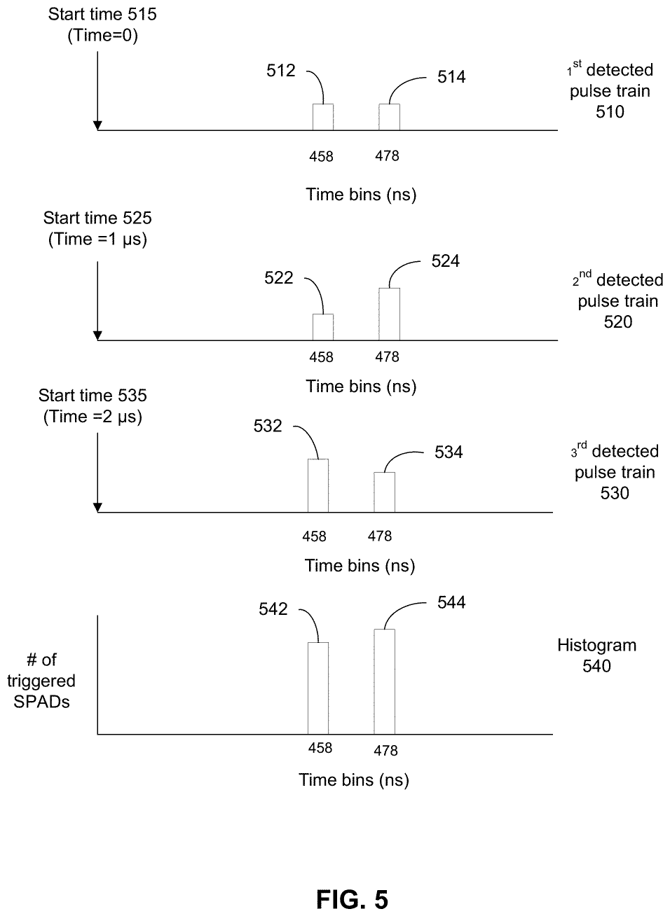

FIG. 5 shows the accumulation of a histogram over multiple pulse trains for a selected pixel according to some embodiments described herein. FIG. 5 shows three detected pulse trains 510, 520 and 530. Each detected pulse train corresponds to a transmitted pulse train that has a same pattern of two pulses separated by a same amount of time. Thus, each detected pulse train has a same pulse pattern, as shown by two time bins having an appreciable value. Counts for other time bins are not shown for simplicity of illustration, although the other time bins may have non-zero values (generally lower than the values in time bins corresponding to detected pulses).

In the first detected pulse train 510, the counts for time bins 512 and 514 are the same. This can result from a same (or approximately the same) number of photodetectors detecting a photon during each of the two time bins, or approximately the same number of photons being detected during the two time bins, depending on the particular photodetectors used. In other embodiments, more than one consecutive time bin can have a non-zero value; but for ease of illustration, individual nonzero time bins have been shown.

Time bins 512 and 514 respectively occur 458 ns and 478 ns after start time 515. The displayed counters for the other detected pulse trains occur at the same time bins relative to their respective start times. In this example, start time 515 is identified as occurring at time 0, but the actual time is arbitrary. The first detection interval for the first detected pulse train can be 1 μs. Thus, the number of time bins measured from start time 515 can be 1,000. After, this first detection interval ends, a new pulse train can be transmitted and detected. The start and end of the different time bins can be controlled by a clock signal, which can be part circuitry that acts as a time-to-digital converter (TDC).

For the second detected pulse train 520, the start time 525 is at 1 μs, at which time the second pulse train can be emitted. Time between start time 515 and start time 525 can be long enough that any pulses transmitted at the beginning of the first detection interval would have already been detected, and thus not cause confusion with pulses detected in the second detection interval. For example, if there is not extra time between shots, then the circuitry could confuse a retroreflective stop sign at 200 m with a much less reflective object at 50 m (assuming a laser cycle of about 1 us). The two detection time intervals for pulse trains 510 and 520 can be the same length and have the same relationship to the respective start time. Time bins 522 and 524 occur at the same relative times of 458 ns and 478 ns as time bins 512 and 514. Thus, when the accumulation step occurs, the corresponding counters can be added. For instance, the counter values at time bin 512 and 522 can be added together.

For the third detected pulse train 530, the start time 535 is at 2 μs, at which time the third pulse train can be emitted. Time bin 532 and 534 also occur at 458 ns and 478 ns relative to start time 535. The counts for corresponding pulses of different pulse trains (as evidenced by the counters) may have different values even though the emitted pulses have a same power, e.g., due to the stochastic nature of the scattering process of light pulses off of objects.

Histogram 540 shows an accumulation of the counts from three detected pulse trains 510, 520, 530 at time bins 542 and 544, which also correspond to 458 ns and 478 ns. Histogram 540 can have fewer time bins than were measured during the respective detection intervals, e.g., as a result of dropping time bins in the beginning or the end of the detection interval or time bins having values less than a threshold. In some implementations, about 10-30 time bins can have appreciable values, depending on the pattern for a pulse train.

As examples, the number of pulse trains emitted during a measurement to create a single histogram can be around 1-40 (e.g., 24), but can also be much higher, e.g., 50, 100, 500, or 1000. Once a measurement is completed, the counts for the histogram can be reset, and another set of pulse trains can be emitted to perform a new measurement. In various embodiments and depending on the number of detection intervals in the respective measurement cycles, measurements can be performed, e.g., every 25, 50, 100, or 500 μs. In some embodiments, measurement intervals can overlap, e.g., so that a given histogram corresponds to a particular sliding window of pulse trains. In such an example, memory can be provided for storing multiple histograms, each corresponding to a different time window. Any weights applied to the detected pulses can be the same for each histogram, or such weights could be independently controlled. In some embodiments, each of a plurality of photosensors may correspond to different fields of view, and each of the plurality of photosensors may comprise a plurality of photodetectors, an respective accumulation circuit, and an respective integration register.

### III. Histogram Data Path

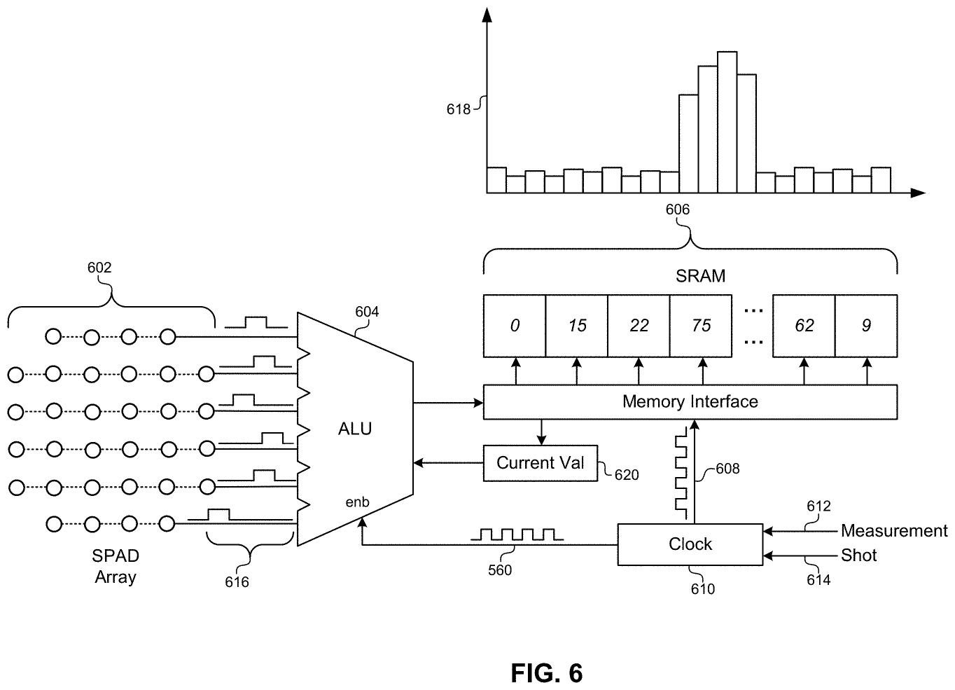

FIG. 6 shows a circuit for receiving photons and generating a set of signals that are stored in a memory representing histogram, according to some embodiments. As described above, an array of photosensors may be used to receive reflected pulses and ambient light in an optical measurement system. A single photosensor 602 may include a plurality of photodetectors. Each photodetector may be implemented by a SPAD or other light-sensitive sensor, and the photodetectors may be arranged in a grid pattern for the photosensor 602 as illustrated in FIG. 6.

Each photodetector in the photosensor 602 may include analog front-end circuitry for generating an output signal indicating when photons are received by the photodetectors. Each photodetector in the photosensor 602 may generate its own signal corresponding to received photons. Thus, the photosensor 602 may generate a set of signals 616 corresponding to the number of photodetectors in the photosensor 602. As described above, the photosensor 602 can correspond to a single pixel of information when displayed or analyzed in later stages of the optical measurement system. When signals are generated in response to received photons (e.g., transitioning from a logical “0” to a logical “1”), this may be referred to as a “positive” signal that shows the corresponding photodetector is triggered.

An arithmetic logic unit (ALU) 604 may be used to implement the functionality of a pixel counter. Specifically, the ALU 604 may receive the set of signals 616 from the individual photodetectors of the photosensor 602 and aggregate a number of these signals that each indicate the detection of a photon and the “triggered” state of the corresponding photodetector. The ALU 604 may include a combinational digital electronic circuit that performs arithmetic and/or other bitwise operations on the set of signals 616. For example, the ALU 604 may receive each of the set of signals 816 as a binary signal (i.e., a “0” or a “1”) as an input or operand to the ALU 604. By aggregating or adding inputs together, the ALU 604 may count a number of positive signals in the set of signals 616 that indicate that photons have been received and the numbers of triggered photodetectors within a particular time bin. For example, by adding each of the signals indicating a “1” signal level, the output of the ALU 604 may indicate the number of signals in the set of signals 616 that are associated with photodetectors that in turn received photons and triggered during the time bin.

The ALU 604 is designed specifically to receive at least a number of inputs that correspond to the number of photodetectors in the photosensor 602. In the example of FIG. 6, the ALU 604 may be configured to receive 32 parallel inputs that are a single bit wide. Internally, the ALU 604 may be implemented with digital logic gates to form a ripple-carry adder, a carry-lookahead adder, a carry-save adder, and/or any other type of adder that can aggregate a relatively large number of inputs with low propagation time. The output of the ALU 604 may be referred to as a “total signal count” and may be represented as an n-bit binary number output from the ALU 604 or from a stage of the ALU 604.

As described above, the output of the ALU 604 may characterize the total number of photons received by the photosensor 602 during a particular time bin. Each time the ALU 604 completes an aggregation operation, the total signal count can be added to a corresponding memory location in a memory 606 representing histogram 618. In some embodiments, the memory 606 may be implemented using an SRAM. Thus, over the course of multiple shots (with each shot including a pulse train) the total signal count from the ALU 604 can be aggregated with an existing value in a corresponding memory location in the memory 606. A single measurement may be comprised of a plurality of shots that populate the memory 606 to generate the histogram 618 of values in the time bins that can be used to detect reflected signals, ambient noise, peaks, and/or other signals of interest.

The ALU 604 may also perform a second aggregation operation that adds the total signal count to an existing value in a memory location of the memory 606. Recall from FIG. 5 that with each shot, a new total signal count may be added to an existing value in the corresponding time bin of the memory 606. In this manner, the histogram 618 can be gradually constructed in the memory 606 over a number of shots. When the total signal count is generated by the ALU 604, a current value 620 of a corresponding memory location for that time bin can be retrieved from the memory 606. The current value 620 can be provided as an operand to the ALU 604, which can be combined with the total signal count from the set of signals 616. In some embodiments, the ALU 604 can be composed of a first stage and a second stage, where the first stage calculates the total signal count from the photosensor 602, and the second stage combines the total signal count with the current value 620 from that time bin's memory location in the memory 606. In some embodiments, the aggregation of the set of signals 616 and the aggregation of total signal count and the current value 620 may be carried out as a single operation. Thus, even though these two operations may functionally be described as separate “aggregations,” they may in fact be performed together using a combination of parallel and sequential circuitry in the ALU 604.

The ALU 604 may receive a periodic signal 560 that triggers the aggregation operation(s). The periodic signal 560 can be produced by a phase-locked loop (PLL) or delay-locked loop (DLL) or any other method of producing a clock signal. The periodic signal 560 may define the length of each time bin. In some embodiments, the periodic signal 560 and the corresponding time bins can be measured relative to a start signal as illustrated in FIG. 3. Each cycle of the periodic signal 560 can cause aggregation operations to execute in the ALU 604 and may cause the memory address of the memory 606 increment to the next time bin. For example, a rising edge of the periodic signal 560 may cause the ALU 604 to produce a result that aggregates the total signal count and the current value 620 together. A corresponding periodic signal 608 may also be sent to a memory interface circuit that increments an address to a memory location of a current time bin such that each cycle also moves to the next time bin in the memory 606.

A clock circuit 610 may be used to generate the periodic signal 560 based on inputs that define shots and measurements for the optical measurement system. For example, a shot input 614 may correspond to the start signal illustrated in FIG. 3. The shot input 614 may reset the address for the memory 606 to a beginning memory location corresponding with a first time bin of the histogram 618. The shot input 614 may also cause the clock circuit 610 to begin generating the periodic signal 560 for the ALU 604 and/or the periodic signal 608 that increments the address for the memory 606. Additionally, the clock circuit 610 may receive a measurement signal 612 that defines the beginning/end of a measurement. A measurement may be comprised of a plurality of shots that incrementally build the histogram 618. The measurement signal 612 may be used to reset the values in the memory 606 such that the histogram can start over for each new measurement.

The memory 606 may include a plurality of registers that accumulate photon counts from photodetectors or the counts of triggered photodetectors. By accumulating photon counts or the counts of triggered photodetectors in respective registers corresponding to time bins, the registers in the memory 606 can store photon counts based on arrival times of the photons. For example, photons arriving in a first time bin can be stored in a first register in the memory 606, photons arriving in a second time bin can be stored in a second register in the memory 606, and so forth. Each shot may include one traversal through each of the registers in the memory 606 corresponding to a time bin for that photosensor. The shot input 614 may be referred to as an enable signal for the plurality of registers in the memory 606 in that the shot input 614 enables the registers in the memory 606 to store results from the ALU 604 during the current shot.

The periodic signal 560 can be generated such that it is configured to capture the set of signals 616 as they are provided asynchronously from the photosensor 602. For example, a threshold circuitry may be configured to hold the output signal high for a predetermined time interval. The periodic signal 560 may be timed such that it has a period that is less than or equal to the hold time for the threshold circuitry. Alternatively, the period of the periodic signal 560 may be a percentage of the hold time for the threshold circuitry, such as 90%, 80%, 75%, 70%, 50%, 110%, 120%, 125%, 150%, 200%, and so forth. Some embodiments may use rising-edge detection circuitry to convert the asynchronous signals from the photodetectors into single clock strobes that use the same clock that runs the ALU 604. This may guarantee that photons are not counted more than once. Other embodiments may alternatively oversample the asynchronous pulses from the photodetectors or use brute-force rising-edge detection.

### IV. Independent Integration Data Path

In order to efficiently detect photosensor or pixel errors of a system, embodiments can use an independent integration register operating in a parallel data path to track the photon counts of each photosensor for a measurement interval (e.g., an image frame to generate a point cloud) and further compare the tracked photon counts in the integration register with the number of aggregated photon counts of the measurement period obtained through the histogram data path for error detections. The independent integration register may receive signals indicating a total photon count (e.g., directly from a sensor, a detector, or from an ALU or any other similar device) for each time bin and accumulate that value. The integration register can record photon or “triggered” photodetector counts before, between, and after shots. The independent integration register provides a readily-available total of photons, or “triggered” photodetectors in some embodiments, for a photosensor or pixel that can be used to be compared with the total signal counts of the histogram data path for fault detection.

A. Using Independent Integration Data Path Monitoring Photodetectors Functionality

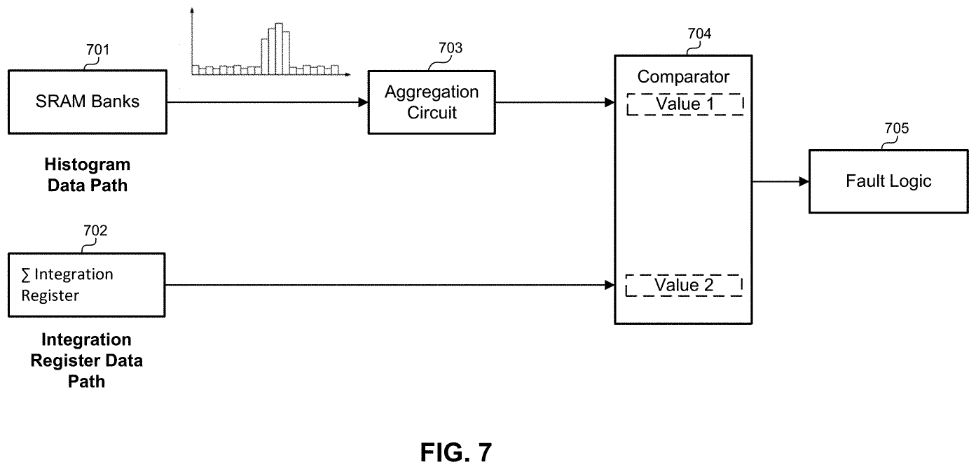

FIG. 7 illustrates aggregation circuitry using the histogram data path and the independent integration data path, according to embodiments of the present invention. As described above in relation to FIG. 6, an ALU (not shown), or any similar circuit capable of performing arithmetic or bitwise operations, can accumulate photon counts received during a corresponding one of the plurality of time bins in each of the plurality of time intervals to represent a histogram of photon counts received during the plurality of time intervals. The photon count output can then be passed to each of the histogram data path and the integration register data path.

For example, through the histogram data path, the accumulated photon count output can be first passed to and stored in a memory 701 representing a histogram of photon counts received during a plurality of time intervals. The memory 701 may include or be formed by a plurality of registers that accumulate photon counts from photodetectors or the counts of triggered photodetectors. By accumulating photon counts or the counts of triggered photodetectors in respective registers corresponding to time bins, the registers in the memory 701 can store photon counts based on arrival times of the photons. For example, photons arriving in a first time bin can be stored in a first register in the memory 701, photons arriving in a second time bin can be stored in a second register in the memory 701, and so forth. Each shot may include one traversal through each of the registers in the memory 701 corresponding to a time bin for that photosensor. In some embodiments, the memory 701 may comprise a plurality of SRAM banks. An aggregation circuit 703 can then aggregate the photon counts of the plurality of time bins in the histogram read from the memory 701 to obtain a first number (“value 1” in FIG. 7) that represents a number of photon counts received from the photodetectors across each of the time bins over any number of shots for the corresponding photosensor. In some embodiments, the aggregation circuit 703 may initiate an aggregation of the photon counts of the plurality of time bins in the histogram read from the memory 701 to obtain a first number (“value 1” in FIG. 7) after the maximum value of the memory 701 is reached for one or more of the registers or after a specified number of time intervals. The number of photon counts can be determined as a sum or a modulus, which can save memory.

On the other hand, through the integration register data path, the photon counts from the one or more photodetectors received during the plurality of time intervals for all of the plurality of time bins are accumulated into an integration register 702 to obtain a second number (“value 2” in FIG. 7). In one example, the accumulation of photon counts can use an output of a summing circuit (e.g., ALU 604) that provides a count for a current time bin, and then a separate aggregation circuit can add the current photon count to the existing count in the register, thereby providing an integration of photon counts across the measurement. In such an example, the summing circuit could be shared for across the two data paths. As another examples, the aggregation circuit can receive signals directly from the detectors and perform a sum, along with a current photon count stored from previous time bins.

The comparator 704 can then compare value 1 and value 2 obtained respectively from the histogram data path and the integration register data path for any inconsistency or difference. A fault logic 705 can flag the corresponding photosensor or pixel as dysfunctional (faulty) or “dysfunctional status” and communicate the sensor fault to relevant parts (e.g., processor) for further actions, if desired.

B. Data Path With An Independent Integration Register

An example of the integration data path is now provided. In this example, a sum is determined of all the photon counts in the integration register. But in other examples, the integration register may be smaller than a maximum number of counts and thus a modulo operation is effectively performed.

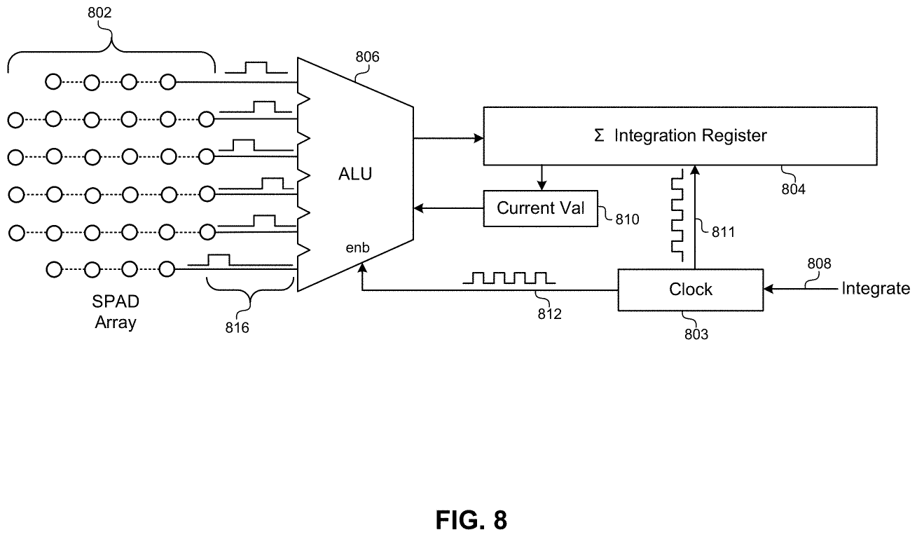

FIG. 8 shows a data path with an integration register, according embodiments to the present invention. The photosensor 802 with the plurality of photodetectors may generate the set of signals 816. An ALU 806 can aggregate the positive signals received during a time bin as described above in FIG. 6. However, instead of storing the total signal count aggregated by the ALU 806 in discrete time bins in the memory 606 in FIG. 6, this independent second data path can add the total signal count to a value stored in an integration register 804 that represents a total number of positive signals received from the photodetectors, or a total number of triggered photodetectors, across each of the time bins over any number of shots. For example, the integration register 804 can provide a current value 810 in the integration register 804 to the ALU 806.

A first stage of the ALU 806 can aggregate the set of signals 816 from the photosensor 802 to generate a total signal count for a current time bin. A second stage of the ALU 806 can then add the total signal count for the current time bin to the current value 810 representing the total photon count or the total number of triggered photodetectors in the integration register 804 and store the updated total photon count or the updated total number of triggered photodetectors in the integration register 804.

An integrate signal 808 may be provided to a clock circuit 803 to begin an integration cycle. The clock circuit 803 can generate a periodic signal 812 that can clock the ALU 806. For example, the periodic signal 812 can define time bins during which the set of signals 816 can be aggregated by the ALU 806. The clock circuit 803 may also generate a periodic signal 811 that is used to latch a new value into the integration register 804. For example, a rising clock edge on the periodic signal 811 may cause the integration register 804 to latch the result from the ALU 806. The result from the ALU 806 may be the aggregated total of the total signal counts and the current value 810 of the integration register 804 before latching the new result value.

The timing associated with the integration register 804 and/or the ALU 806 may be independent from the timing of the clock circuit 610 in the histogram data path of FIG. 6. For example, the periodic signal 812 in the integration data path need not be phase-aligned with the periodic signal 560 in the histogram data path. These periodic signals 812, 560 may also have different periods and/or duty cycles. Additionally, the integrate signal 808 that defines the beginning and/or length of an integration cycle need not be aligned with or derived from the shot input 614 or the measurement signal 612 of the histogram data path. Thus, the timing of the histogram data path and the integration data path can be completely independent from each other.

In some embodiments, the integration register 804 can accumulate photon counts from the photosensor 802 during one or more intervals that are defined by the integrate signal 808. In this sense, the integrate signal 808 may also be referred to as an “enable” signal in that it enables the integration register 804 to accumulate photon counts. In some embodiments, each enablement of the integrate signal 808 may reset the integration register 804 such that the accumulation of the photon counts starts over. In other embodiments, each enablement of the integrate signal 808 may restart the integration register 804 such that it continues accumulating photon counts or the number of triggered photodetectors where it left off. This allows the integration register 804 to accumulate photon counts or the number of triggered photodetectors over one or more time intervals that can be defined by the integrate (i.e., enable) signal 808.

C. In Pixel Configurations In The Histogram Data Path

An example of the two data paths from the photosensor to the comparator is now provided.

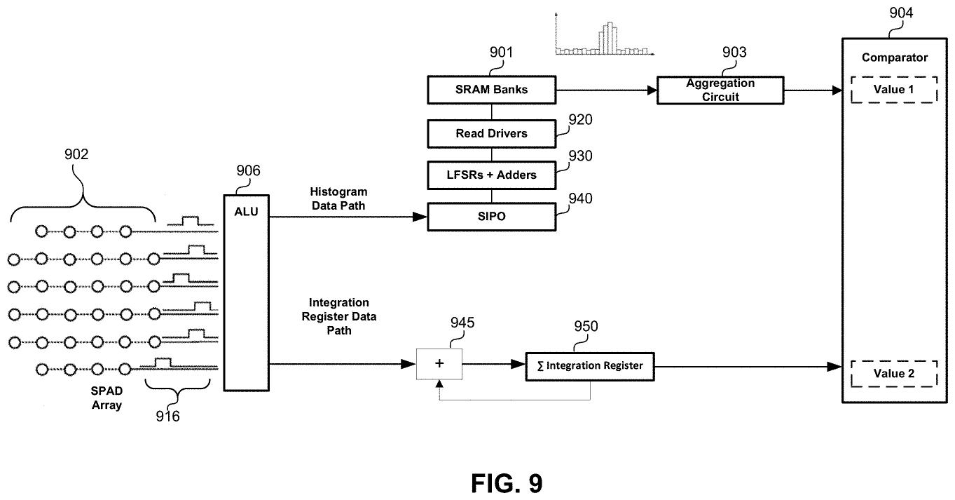

FIG. 9 illustrates aggregation circuitry between the histogram data path and the independent integration data path according to some embodiments of the present invention. The photosensor 902 with the plurality of photodetectors may generate the set of signals 916 reflecting the detection of photon counts. An ALU 906, or any similar accumulation circuit capable of performing arithmetic or bitwise operations, can accumulate the total positive signals (“total signal count”) or photon counts received during a corresponding one of the plurality of time bins in each of the plurality of time intervals to represent a histogram of photon counts received during the plurality of time intervals as described above in FIG. 6. The accumulated photon counts can then be passed to each of the histogram data path and the integration register data path.

In some embodiments, before accumulating the photon counts from the one or more photodetectors received during multiple time bins, pipelining operations may be performed over the photon counts from the one or more photodetectors received during multiple time bins, wherein the photon counts for the multiple time bins are simultaneously written to multiple of the plurality of first registers. According to some embodiments, when the accumulated photon count produced by the ALU 906 is passed to the histogram data path, it can be first passed to the Serial in Parallel Out Shift Register (SIPO) 940. The SIPO 940 can perform pipelining operations (e.g., by storing the K sampled photon detection events in a K-bit shift register) to convert the input data into parallel data strings and shift the same number of pipelined samples into a temporary small memory (e.g., by transferring the sampled data into a K-bit register responsive to every K-th clock signal) for further processing and/or operations. The pipelined samples can then be passed to a hybrid adder circuit 930 that includes both Linear-Feedback Shift Registers (LFSR) and adders. The read driver 920 enables the access to the data stored in the main memory 901. In some embodiments, the memory 901 may include or be formed by a plurality of registers that accumulate photon counts from the plurality of photodetectors or the counts of triggered photodetectors. By accumulating photon counts or the counts of triggered photodetectors in respective registers corresponding to time bins, the registers in the memory 901 can store photon counts based on arrival times of the photons. For example, photons arriving in a first time bin can be stored in a first register in the memory 901, photons arriving in a second time bin can be stored in a second register in the memory 901, and so forth. Each shot may include one traversal through each of the registers in the memory 901 corresponding to a time bin for that photosensor. In some embodiments, the memory 901 may comprise a plurality of SRAM banks. In some embodiments, the main memory 901 may be partitioned into a number of K parallel memory banks that can integrate and store the pipelined samples transferred from the adder circuit 930 for histogramming and/or other operations. In some embodiments, the histogram data path may include a pipelining circuit to perform pipelining operations, wherein the pipelining circuit is configured to perform pipelining operations over the accumulated photon counts from the one or more photodetectors received during multiple time bins, wherein the histogram data path stores accumulated photon counts for each of the multiple time bins.

Similar as described in FIG. 7 above, the pipelined samples passed to and stored in the memory 901 represent a histogram of photon counts received during a plurality of time intervals. The aggregation circuit 903 can then further aggregate the pipelined samples from the memory 901 to obtain a first number (“value 1”) that represents a total number of photon counts received from the photodetectors across each of the time bins over any number of shots for the corresponding photosensor or pixel.

As described above, through the integration data path, the photon counts from the one or more photodetectors received during the plurality of time intervals for all of the plurality of time bins are independently accumulated into an integration register 950 to obtain a second number (“value 2”). The accumulation can use an adder 945 to add the current photon count for a current time bin to the existing integrated count. If integration register 950 has a maximum value that is below the total photon count, then the count will flip back to zero, effectively providing a modulo operation. Aggregation circuit 903 can perform a similar modulo operation.

The comparator 904 can then compare value 1 and value 2 obtained respectively from the histogram data path and the integration register data path for any inconsistency or difference. A fault logic (not shown) can flag the corresponding photosensor or pixel as dysfunctional or “dysfunctional status” and communicate the sensor fault to relevant parts (e.g., processor) for further actions.

The embodiments provided are for illustration and should extend to any possible in-pixel configurations that might improve the pixels' capacities or performance in any aspect. In some embodiments, wherein the aggregation circuit and the integration register are part of a single integrated circuit.

D. The Implementation Of Modulo Operations

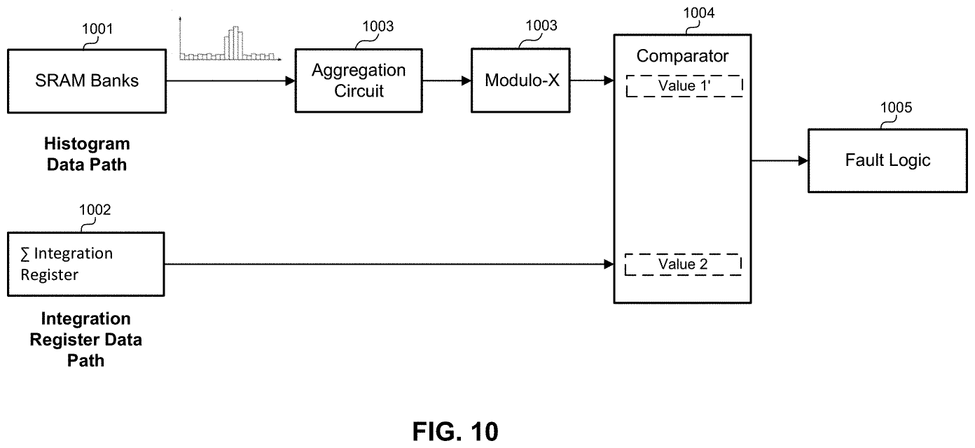

FIG. 10 illustrates the implementation of modulo operations into some embodiments of the present invention.

As described above in relation to FIG. 7, a single ALU (not shown), or any similar circuit capable of performing arithmetic or bitwise operations, can accumulate the total positive signals (“total signal count”) or photon counts received during a corresponding one of the plurality of time bins in each of the plurality of time intervals to represent a histogram of photon counts received during the plurality of time intervals. The accumulated photon counts can then be passed to each of the histogram data path and the integration register data path. For example, through the histogram data path, the accumulated photon count output can be first passed to and stored in a memory 1001 representing a histogram of photon counts received during a plurality of time intervals.

In some embodiments, the memory 1001 may include or be formed by a plurality of registers that accumulate photon counts from the plurality of photodetectors or the counts of triggered photodetectors. By accumulating photon counts or the counts of triggered photodetectors in respective registers corresponding to time bins, the registers in the memory 1001 can store photon counts based on arrival times of the photons. For example, photons arriving in a first time bin can be stored in a first register in the memory 1001, photons arriving in a second time bin can be stored in a second register in the memory 1001, and so forth. Each shot may include one traversal through each of the registers in the memory 1001 corresponding to a time bin for that photosensor. In some embodiments, the memory 1001 may comprise a plurality of SRAM banks.

The aggregation circuit 1003 can then further aggregate the photon counts of the plurality of time bins in the histogram read from the memory 1001 to obtain an intermediate value (“value 1” in FIG. 7) that represents a total number of photon counts received from the photodetectors across each of the time bins over any number of shots for the corresponding photosensor. Before being passed to the comparator 1004, the intermediate value can be processed by a modulo operation, Mod-X, that may reduce the size of the value to be the remainder after division by X, and output, value 1′. Typically, a Mod-X operation returns the remainder or signed remainder of a division, after the input is divided by number X. The divisor number X could be any integer, preferably odd numbers like 3, 5, 7, 13, 17, 21, 23, 27, 29, 31, 33, 37, 39, 41 etc.

Through the integration register data path, the total signal count can be passed and accumulated in the integration register 1002 operating in parallel with the histogram data path to obtain a second number of accumulated value (“value 2”). As mentioned above, the integration register can have a maximum value, which can correspond to X, after which the count reverts to an initial value. In this manner, a smaller integration register can be used, thereby allowing a smaller circuit. The probability of the remainders being the same can be small, particularly if X is an odd number.

The comparator 1004 can then compare value 1′ and value 2 obtained respectively from the histogram data path and the integration register data path for any inconsistency or difference. Fault logic 1005 can flag the corresponding photosensor or pixel as dysfunctional or “dysfunctional status” and communicate the sensor fault to relevant parts (e.g., processor) for further actions.

### V. Method for Using a Sensor Fault Detection System

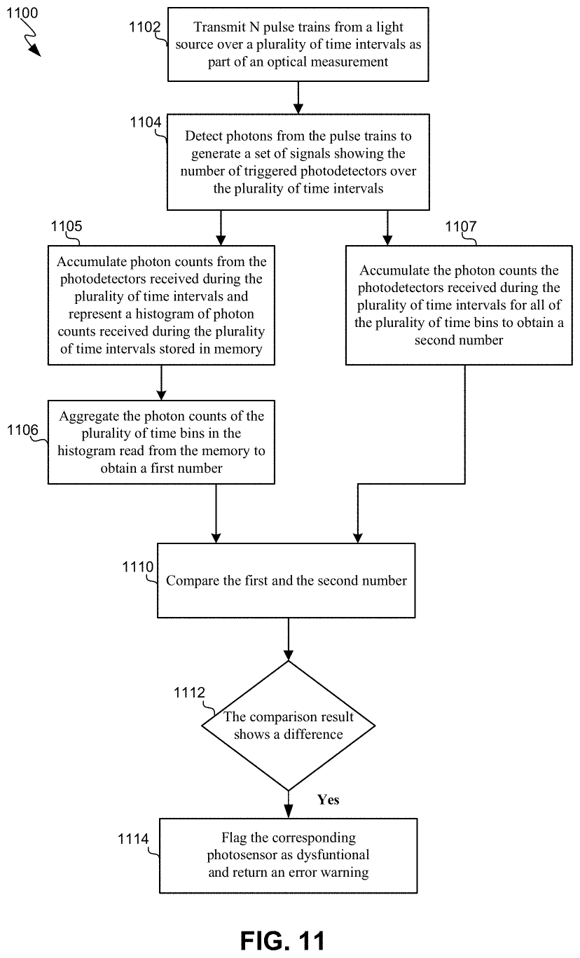

FIG. 11 shows a flowchart 1100 of a method of using a sensor fault detection system, according to some embodiments.

At block, 1102, the method may include transmitting N pulse trains from a light source over a plurality of time intervals as part of an optical measurement. Each of the pulse trains may include one or more pulses from the light source, and each of the pulse trains may correspond to a different time interval that is triggered by a start signal. The time interval may represent a single shot, and the N pulse trains may represent a measurement comprising a plurality of shots. The value of “N” may be an integer value greater than or equal to one (e.g., one, two, three, four, five, etc.).

At block 1104, the method may also include detecting photons of the N pulse trains and photons from ambient light using photodetectors of the photosensor. The photodetectors may be implemented by SPADs and may generate a plurality of signals over the plurality of time intervals for each of the SPADs. A signal from the photodetector indicates whether photons were detected and the corresponding photodetector was triggered during a time bin in the current time interval. As described above, each time interval may be subdivided into a plurality of time bins that correspond to a frequency with which the ALU aggregates photon counts, or the number of triggered photodetectors, and updates values in a histogram and/or integration register.

At block 1105, the method may accumulate, through a first data path into a plurality of first registers, photon counts from the one or more photodetectors received during the plurality of time intervals, wherein each of the plurality of time intervals is subdivided into a plurality of time bins, and each of the plurality of first registers accumulates photon counts received during a corresponding one of the plurality of time bins in each of the plurality of time intervals to represent a histogram of photon counts received during the plurality of time interval. The histogram can be stored in memory. The length of the time bin may be dependent on the frequency of a periodic signal. The periodic signal may also be used to clock the registers such that photon counts or the corresponding signals are not missed or double-counted.

At block 1106, the method may aggregate the photon counts of the plurality of time bins in the histogram read from the memory to obtain a first number.

At block 1107, the method may further include accumulating, through a second data path into an integration register, the photon counts from the one or more photodetectors received during the plurality of time intervals for all of the plurality of time bins to obtain a second number. Note that these time bins for the integration data path may be defined by an enable signal that is specific to the integration register. Thus, these time bins may be different and independent from time bins used by the histogram data path, which may be defined by a separate and independent enable or shot signal. This accumulation of photon counts may include some or all of the signals received in the plurality of time bins, regardless of whether those time bins correspond to a shot or pulse train in the histogram data path. The integration register may provide a current value to an arithmetic logic circuit, which can add the current value to the total positive signal count from the photosensor during the time bin. Latching a new value into the integration register may be based on the periodic signal that is used to derive the length of the time bin and aggregate the total positive signal count for the photosensor.

At block 1110, the method may include comparing the first number from block 1106 against the second number from block 1107. Note that the first number from block 1106 may be processed or operated before entering the comparison block 1110.

If the comparison result shows a comparison difference or consistency at block 1112, the corresponding pixel will be flagged as “dysfunction” and an error warning will be returned for further actions at block 1114.

### VI. Multiple Lidar Units

Depending on their intended purpose or application, lidar sensors can be designed to meet different FOV and different range requirements. For example, an automobile (e.g., a passenger car) outfitted with lidar for autonomous driving might be outfitted with multiple separate lidar sensors including a forward-facing long range lidar sensor, a rear-facing short range lidar sensor and one or more short range lidar sensors along each side of the car.

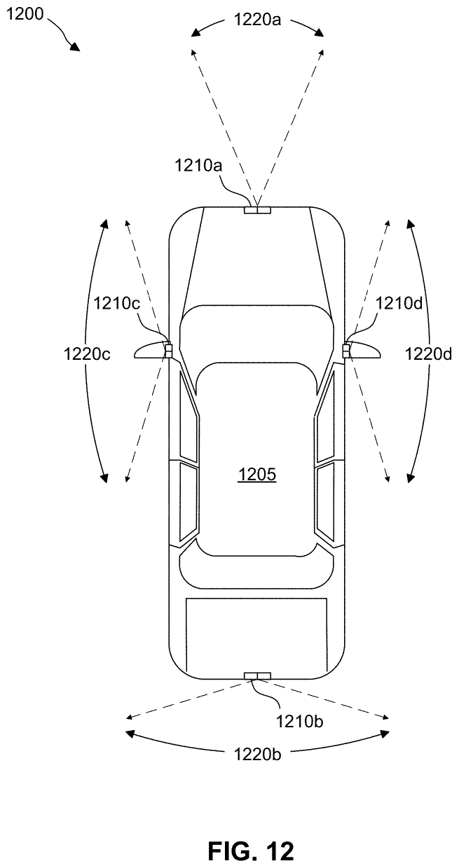

FIG. 12 is a simplified illustration of an automobile 1200 in which four solid-state flash lidar sensors 1210a-d are included at different locations along the automobile. The number of lidar sensors, the placement of the lidar sensors, and the fields of view of each individual lidar sensors can be chosen to obtain a majority of, if not the entirety of, a 360-degree field of view of the environment surrounding the vehicle some portions of which can be optimized for different ranges. For example, lidar sensor 1210a, which is shown in FIG. 10 as being positioned along the front bumper of automobile 1200, can be a long range (200 meter), narrow field of view unit, while lidar sensors 1210b, positioned along the rear bumper, and lidar systems 1210c, 1210d, positioned at the side mirrors, are short range (50 meter), wide field of view systems.

Despite being designed for different ranges and different fields of view, each of the lidar sensors 1210a-1210d can be a lidar system according to embodiments disclosed herein. Indeed, in some embodiments, the only difference between each of the lidar sensors 1210a-1210d is the properties of the diffuser (e.g., diffuser 136). For example, in long range, narrow field of view lidar sensor 1210a, the diffuser 136 is engineered to concentrate the light emitted by the emitter array of the lidar system over a relatively narrow range enabling the long-distance operation of the sensor. In the short range, wide field of view lidar sensor 110b, the diffuser 136 can be engineered to spread the light emitted by the emitter array over a wide angle (e.g., 180 degrees). In each of the lidar sensors 1210a and 1210b, the same emitter array, the same detector array and the same controller, etc. can be used thus simplifying the manufacture of multiple different lidar sensors tailored for different purposes. Any or all of lidar sensors 1210a-1210d can incorporate use of an integration register for detecting faulty pixels as described herein.

### VII. Additional Embodiments

In the above detailed description, numerous specific details are set forth to provide a thorough understanding of embodiments of the present disclosure. However, it will be understood by those skilled in the art that the present disclosure can be practiced without these specific details. For example, while various embodiments set forth above described may use SPADs, other detectors can be employed in embodiments. As another example, some of the embodiments discussed above include a specific number of rows and/or columns of sensors or detectors within a sensor. It is to be understood that those embodiments are for illustrative purposes only and embodiments are not limited to any particular number of columns or rows of sensors or detectors within a sensor.

Any of the computer systems or circuits mentioned herein may utilize any suitable number of subsystems. The subsystems can be connected via a system bus. As examples, subsystems can include input/output (I/O) devices, system memory, storage device(s), and network adapter(s) (e.g., Ethernet, Wi-Fi, etc.), which can be used to connect a computer system to other devices (e.g., an engine control unit). System memory and/or storage device(s) may embody a computer readable medium.

A computer system can include a plurality of the same components or subsystems, e.g., connected together by external interface, by an internal interface, or via removable storage devices that can be connected and removed from one component to another component. In some embodiments, computer systems, subsystem, or apparatuses can communicate over a network.

Aspects of embodiments can be implemented in the form of control logic using hardware circuitry (e.g., an application specific integrated circuit or field programmable gate array) and/or using computer software with a generally programmable processor in a modular or integrated manner. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the invention has been presented for the purposes of illustration and description. It is not intended to be exhaustive or to limit the invention to the precise form described, and many modifications and variations are possible in light of the teaching above.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted to be prior art.

What is claimed:

1. A method of performing an optical measurement system, comprising:
transmitting N pulse trains from a light source over a plurality of time intervals as part of an optical measurement, wherein each of the N pulse trains includes one or more pulses from the light source and corresponds to a different time interval that is triggered by a start signal, and wherein N is an integer greater than or equal to one;
detecting photons of the N pulse trains using one or more photodetectors of a photosensor of the optical measurement system, thereby generating a plurality of signals over the plurality of time intervals for each of the one or more photodetectors, wherein a signal from a photodetector indicates whether the photodetector was triggered during a time bin of a time interval;
accumulating, through a first data path into a plurality of first registers, photon counts from the one or more photodetectors received during the plurality of time intervals, wherein each of the plurality of time intervals is subdivided into a plurality of time bins, and each of the plurality of first registers accumulates photon counts received during a corresponding one of the plurality of time bins in each of the plurality of time intervals to represent a histogram of photon counts received during the plurality of time intervals, wherein the plurality of first registers form a memory;
aggregating the photon counts of the plurality of time bins in the histogram read from the memory to obtain a first number;
accumulating, through a second data path, the photon counts from the one or more photodetectors received during the plurality of time intervals for the plurality of time bins to obtain a second number; and
determining whether a fault exists by comparing the first number and the second number.

2. The method of claim 1, wherein an aggregation circuit that is connected to the plurality of first registers is used to aggregate the photon counts of the plurality of time bins in the histogram read from the memory to obtain the first number, wherein the aggregation circuit initiates aggregating the photon counts of the plurality of time bins in the histogram read from the memory to obtain the first number after a maximum value of the memory is reached for one or more of the plurality of first registers or after a specified number of time intervals.

3. The method of claim 1, wherein the second data path includes an integration register that accumulates the photon counts.

4. The method of claim 1, wherein at least one of the first number and the second number is determined using a modulo operation.

5. The method of claim 4, wherein the modulo operation uses an odd number.

6. The method of claim 1, wherein the one or more photodetectors comprise single-photon avalanche diodes (SPADs).

7. The method of claim 1, wherein the light source is a vertical cavity surface emitting laser (VCSEL).

8. The method of claim 1, further comprising:
flagging the photosensor responsive to the first number and the second number not being equal.

9. The method of claim 1, further comprising:
before accumulating into the plurality of first registers, performing pipelining operations over the photon counts from the one or more photodetectors received during multiple time bins, wherein the photon counts for the multiple time bins are simultaneously written to multiple of the plurality of first registers.

10. The method of claim 9, wherein the first data path further comprises a hybrid adder circuit that includes at least one linear-feedback shift register (LFSR) and at least one adder.

11. An optical measurement system comprising:
a light source configured to transmit N pulse trains over a plurality of time intervals as part of an optical measurement, wherein each of the N pulse trains includes one or more pulses from the light source and corresponds to a different time interval that is triggered by a start signal, and wherein N is an integer greater than or equal to one;
a photosensor comprising one or more photodetectors configured to detect photons of the N pulse trains, thereby generating a plurality of signals over the plurality of time intervals for each of the one or more photodetectors, wherein a signal from a photodetector indicates whether the photodetector was triggered during a time bin of a time interval;
a plurality of first registers configured to accumulate, through a first data path, photon counts from the one or more photodetectors received during the plurality of time intervals, wherein each of the plurality of time intervals is subdivided into a plurality of time bins, and each of the plurality of first registers accumulates photon counts received during a corresponding one of the plurality of time bins in each of the plurality of time intervals to represent a histogram of photon counts received during the plurality of time intervals, wherein the plurality of first registers form a memory;
an aggregation circuit configured to aggregate the photon counts of the plurality of time bins in the histogram read from the memory to obtain a first number;
an integration register configured to accumulate, through a second data path, the photon counts from the one or more photodetectors received during the plurality of time intervals for the plurality of time bins to obtain a second number; and
a comparator configured to compare the first number and the second number.

12. The optical measurement system of claim 11, wherein the integration register is connected to an adder that is configured to add the photon counts for a current time bin with a count stored in the integration register.

13. The optical measurement system of claim 11, further comprising fault logic configured to flag a dysfunctional status of the corresponding photosensor when the comparator indicates the first number does not equal the second number.

14. The optical measurement system of claim 11, wherein the plurality of signals from the one or more photodetectors is comprised of binary signals.

15. The optical measurement system of claim 11, further comprising a periodic signal that causes the aggregation circuit to aggregate the signals received during each of the plurality of time bins.

16. The optical measurement system of claim 15, wherein the first data path includes a pipelining circuit, wherein the pipelining circuit is configured to perform pipelining operations over the accumulated photon counts from the one or more photodetectors received during multiple time bins, wherein the first data path stores accumulated photon counts for each of the multiple time bins.

17. The optical measurement system of claim 11, wherein the aggregation circuit and the integration register are part of a single integrated circuit.

18. The optical measurement system of claim 11, wherein the aggregation circuit comprises:
a first stage configured to aggregate, for each of the plurality of time bins in the plurality of time intervals, a number of positive signals in a set of signals received for the time bin; and
a second stage configured to aggregate the photon counts for each of the plurality of time bins in each of the plurality of time intervals.

19. The optical measurement system of claim 18, wherein the first stage of the aggregation circuit is shared between the integration register and the memory that stores the histogram of photon counts for each of the plurality of time bins across the plurality of time intervals.

20. The optical measurement system of claim 11, further comprising a plurality of photosensors that each correspond to different fields of view, each of the plurality of photosensors comprising a plurality of photodetectors, a respective accumulation circuit, and a respective integration register.
